(19) United States
(12) Patent Application Publication
(10) Pub. No.: US 2024/0302221 A1
(43) Pub. Date: Sep. 12, 2024

(54) Oven Device with Internal Meat Thermometer Device

(71) Applicant: David Kogut, Carlisle, PA (US)

(72) Inventor: David Kogut, Carlisle, PA (US)

(21) Appl. No.: 18/334,445

(22) Filed: Jun. 14, 2023

Related U.S. Application Data
(60) Provisional application No. 63/489,590, filed on Mar. 10, 2023.

(51) Int. Cl. G01K 13/00; G01K 1/02

(52) U.S. Cl. CPC G01K 13/00; G01K 1/02; G01K 2207/06

(57) ABSTRACT

An oven device with internal meat thermometer is provided. The device is primarily comprised of an improved oven that allows a user to monitor the temperature of food within the interior space of the oven of the device. More specifically, the device allows a user to monitor the internal temperature of food cooking in the oven via at least one temperature probe that can be inserted into food cooking in the oven. The temperature reading of the probe is then displayed on an external display of the oven.

### CROSS-REFERENCE TO RELATED APPLICATION

The present application claims priority to, and the benefit of, U.S. Provisional Application No. 63/489,590, which was filed on Mar. 10, 2023, and is incorporated herein by reference in its entirety.

### FIELD OF THE INVENTION

The present invention relates generally to the field of temperature probes. More specifically, the present invention relates to an oven device with an internal meat thermometer. The internal thermometer can be placed inside meat cooking within the oven to display the internal temperature of the meat via a display in real time. Accordingly, the present disclosure makes specific reference thereto. Nonetheless, it is to be appreciated that aspects of the present invention are also equally applicable to other like applications, devices, and methods of manufacture.

### BACKGROUND

Many types of meat must be cooked to a minimum temperature to ensure they are safe for human consumption. In addition, some meats must be removed from a heat source once they reach a specific internal temperature to ensure the meat has the desired consistency. When cooking meat in an oven, opening the oven door to check the internal temperature of the meat with a temperature probe can allow heat to escape the oven, which may cause the meat to cook unevenly. In addition, opening the oven door leaves an individual open to being burned by hot steam escaping the oven.

Therefore, there exists a long-felt need in the art for an improved meat temperature device. There also exists a long-felt need in the art for a meat temperature device that allows a user to check the internal temperature of a piece of meat cooking within an oven. More specifically, there exists a long-felt need in the art for an oven device with internal meat thermometer, wherein the device allows a user to cook meat in an oven and ascertain the internal temperature of the meat without having to open the oven door.

The subject matter disclosed and claimed herein, in one embodiment thereof, comprises an oven device with internal meat thermometer device. The device is primarily comprised of an improved oven. The device allows a user to monitor the temperature of food within the interior space of the oven of the device via at least one temperature probe that can be inserted into food cooking in the oven. The temperature reading of the probe is then displayed on an external display of the oven. In one embodiment, a user can select a specific internal temperature, wherein a speaker produces an audible alarm/sound when the internal temperature is reached.

In this manner, the oven device with internal meat thermometer device of the present invention accomplishes all the foregoing objectives and provides an improved meat temperature device. The device also allows a user to check the internal temperature of a piece of meat cooking in an oven. More specifically, the device allows a user to cook meat in an oven and ascertain the internal temperature of the meat without having to open the oven door.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an oven device with internal meat thermometer device. The device is primarily comprised of an improved oven. The device allows a user to monitor the temperature of food within the interior space of the oven of the device.

To allow for said temperature monitoring, the interior space is comprised of at least one female receptacle that receives at least one plug of a meat thermometer assembly. The plug provides power to at least one temperature probe and allows electrical communication from at least one sensor of the probe to be communicated via wired electrical communication with at least one display of the device.

The probe has at least one pointed tip to allow the probe to easily penetrate food such as, but not limited to, meat. The probe is comprised of at least one sensor that detects the internal temperature of the food and transmits said temperature in real time to at least one display of the oven via a connection wire that places the plug in wired electrical communication with the receptacle, which is in wired electrical communication with the display via at least one wire. The display is preferably a separate display from any existing type of oven display known in the art. However, in one embodiment the display may be integrated into an existing oven display known in the art.

The display shows the user the real time, internal temperature of the food being cooked within the oven via the probe. In one embodiment, the display is comprised of a temperature select button which allows a user to select the desired temperature for the food. Once said desired temperature is recorded by the probe, the display may produce an audible sound or alarm via at least one speaker. In this manner, a user need not continuously watch the display until the food reaches the desired temperature.

The present invention is also comprised of a first method of using the device. First, a device is provided comprised of an oven comprised of an interior space with a female receptacle, a meat thermometer assembly comprised of a plug connected to a probe with a sensor via a connection wire, and a display. Then, a piece of food, such as, but not limited to, a piece of meat, is placed into the interior space for cooking. Then, the probe is placed into the meat such that the probe can record the internal temperature of the meat. Next, the internal temperature of the meat can be observed while cooking in the oven until the internal temperature of the meat has reached a desired internal temperature. Then, the meat can be removed from the oven once said desired temperature is reached.

The invention may also be comprised of a second method of using the device. First, a device is provided comprised of an oven comprised of an interior space with a female receptacle, a meat thermometer assembly comprised of a plug connected to a probe with a sensor via a connection wire, and a display. Then, a piece of food, such as, but not limited to, a piece of meat, is placed into the interior space for cooking. Then, the probe is placed into the meat such that the probe can record the internal temperature of the meat. Next, a user can select a desired internal temperature of the meat via a temperature select button. Then, the internal temperature of the meat can be observed while cooking within the oven until the internal temperature of the meat has reached a desired internal temperature, at which time the device produces a sound or alarm via a speaker of the device. Then, the meat can be removed from the oven once said desired temperature is reached.

Accordingly, the oven device with internal meat thermometer device of the present invention is particularly advantageous as it provides an improved meat temperature device. The device also allows a user to check the internal temperature of a piece of meat cooking in an oven. More specifically, the device allows a user to cook meat in an oven and ascertain the internal temperature of the meat without having to open the oven door. In this manner, the oven device with internal meat thermometer device overcomes the limitations of existing methods and devices for measuring the internal temperature of cooking meat/food known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of an interior space of one potential embodiment of an oven device with internal meat thermometer device of the present invention while being used to cook food in accordance with the disclosed architecture;

FIG. 2 illustrates an enhanced perspective view of an interior space of one potential embodiment of an oven device with internal meat thermometer device of the present invention in accordance with the disclosed architecture;

FIG. 3 illustrates a top view of a meat thermometer assembly of one potential embodiment of an oven device with internal meat thermometer device of the present invention in accordance with the disclosed architecture;

FIG. 4 illustrates a front view of a display of a meat thermometer assembly of one potential embodiment of an oven device with internal meat thermometer device of the present invention in accordance with the disclosed architecture;

FIG. 5 illustrates a flowchart of a method of using one potential embodiment of an oven device with internal meat thermometer device of the present invention in accordance with the disclosed architecture; and

FIG. 6 illustrates a flowchart of a method of using one potential embodiment of an oven device with internal meat thermometer device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved meat temperature device. There also exists a long-felt need in the art for a meat temperature device that allows a user to check the internal temperature of a piece of meat cooking within an oven. More specifically, there exists a long-felt need in the art for an oven device with internal meat thermometer wherein the device allows a user to cook meat in an oven and ascertain the internal temperature of the meat without having to open the oven door.

The present invention, in one exemplary embodiment, is comprised of an oven device with an internal meat thermometer device. The device is primarily comprised of an improved oven that allows a user to monitor the temperature of food within the interior space of the oven of the device. To allow for said temperature monitoring, the interior space is comprised of at least one female receptacle that receives at least one plug of a meat thermometer assembly. The plug provides power to at least one temperature probe and allows electrical communication from at least one sensor of the probe to be communicated via wired electrical communication with at least one display of the device. The probe has at least one pointed tip to allow the probe to easily penetrate food such as, but not limited to, meat. The probe is comprised of at least one sensor that detects the internal temperature of the food and transmits said temperature in real time to at least one display of the oven via a connection wire that places the plug in wired electrical communication with the receptacle, which is in wired electrical communication with the display via at least one wire. The display is preferably a separate display from any existing type of oven display known in the art. However, in one embodiment, the display may be integrated into an existing oven display known in the art.

While cooking meat, the display shows the user the real time, internal temperature of the meat being cooked within the oven via the probe. In one embodiment, the display is comprised of a temperature select button which allows a user to select the desired temperature for the food. Once said desired temperature is recorded by the probe, the display may produce an audible sound or alarm via at least one speaker. In this manner, a user need not continuously watch the display until the food reaches the desired temperature.

The present invention is also comprised of a first method of using the device. First, a device is provided comprised of an oven comprised of an interior space with a female receptacle, a meat thermometer assembly comprised of a plug connected to a probe with a sensor via a connection wire, and a display. Then, a piece of food, such as, but not limited to, a piece of meat, is placed into the interior space for cooking. Then, the probe is placed into the meat, such that the probe can record the internal temperature of the meat. Next, the internal temperature of the meat can be observed while cooking within the oven until the internal temperature of the meat has reached a desired internal temperature. Then, the meat can be removed from the oven once said desired temperature is reached.

The invention may also be comprised of a second method of using the device. First, a device is provided comprised of an oven comprised of an interior space with a female receptacle, a meat thermometer assembly comprised of a plug connected to a probe with a sensor via a connection wire, and a display. Then, a piece of food, such as, but not limited to, a piece of meat, is placed into the interior space for cooking. Then, the probe is placed into the meat, such that the probe can record the internal temperature of the meat. Next, a user can select a desired internal temperature of the meat via a temperature select button. Then, the internal temperature of the meat can be observed while cooking within the oven until the internal temperature of the meat has reached a desired internal temperature, at which time the device produces a sound or alarm via a speaker of the device. Then, the meat can be removed from the oven once said desired temperature is reached.

Accordingly, the oven device with internal meat thermometer device of the present invention is particularly advantageous as it provides an improved meat temperature device. The device also allows a user to check the internal temperature of a piece of meat cooking in an oven. More specifically, the device allows a user to cook meat in an oven and ascertain the internal temperature of the meat without having to open the oven door. In this manner, the oven device with internal meat thermometer device overcomes the limitations of existing methods and devices for measuring the internal temperature of cooking meat/food known in the art.

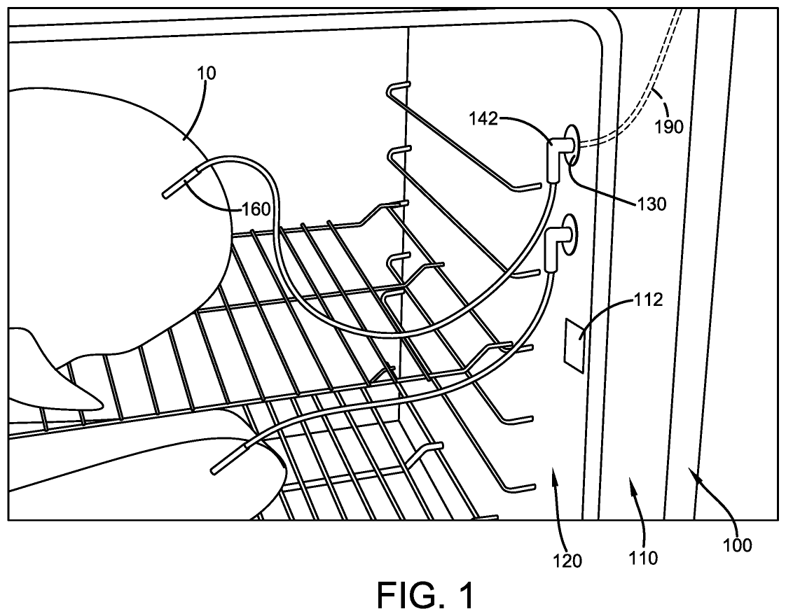

Referring initially to the drawings, FIG. 1 illustrates a perspective view of an interior space one potential embodiment of an oven device with internal meat thermometer device 100 of the present invention while being used to cook food in accordance with the disclosed architecture. The device 100 is primarily comprised of an improved oven 110. The oven 110 is preferably comprised of all features 112 of conventional ovens known in the art. Said features include, but are not limited to, a heating element, a door, an interior rack, a stovetop, a button, a display, etc. It should be noted that the present invention intends to provide an improvement to said existing ovens with said existing features. As a result, the present disclosure focuses on the improvements the device 100 provides and not on existing known features of existing ovens 110 that the device 100 provides.

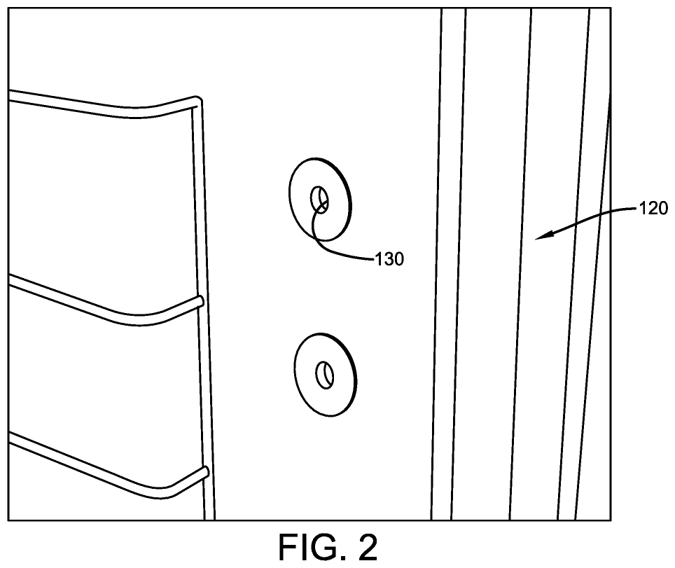

The device 100 allows a user to monitor the temperature of food 10 within the interior space 120 of the oven 110 of the device 100. More specifically, the interior space 120 is comprised of at least one female receptacle 130, as seen in FIG. 2. The female receptacle 130 receives at least one plug 142 of a meat thermometer assembly 140. The receptacle 130 and plug 142 may be any type of reciprocating connection receptacle and plug 142 that provides power to at least one temperature probe 160 and allows electrical communication from at least one sensor 164 of the probe 160 to be communicated via wired electrical communication with at least one display 170 of the device 100.

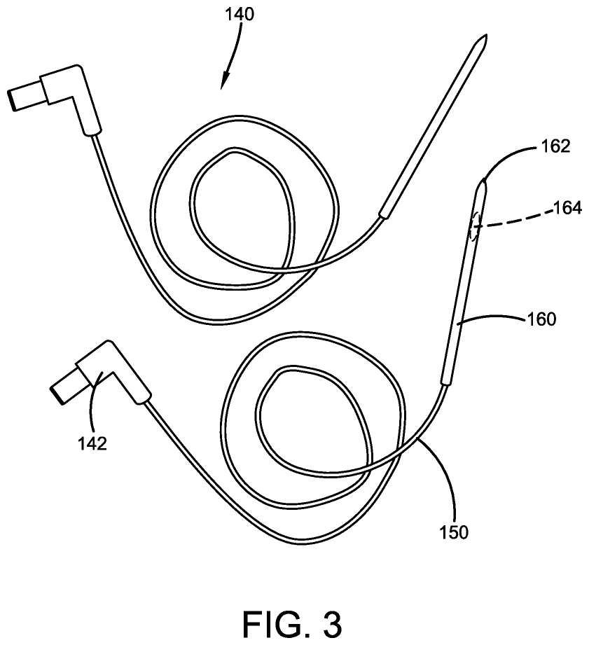

The meat thermometer assembly 140 is comprised of at least one probe 160, as seen in FIG. 3. The probe 160 is preferably made from a metal material. The probe 160 also has at least one pointed tip 162 to allow the probe 160 to easily penetrate food 10 such as, but not limited to, meat.

The probe 160 is comprised of at least one sensor 164. The sensor 164 detects the internal temperature of the food 10 and transmits said temperature 180 in real time to at least one display 170 of the oven 110 via a connection wire 150 that places the plug 142 in wired electrical communication with the receptacle 130, which is in wired electrical communication with the display 170 via at least one wire 190.

In one embodiment, the sensor 164 is comprised of a thermocouple sensor. Said sensors are preferably, but not limited to, a Type-K sensor made from nickel and chromium. In another embodiment, the sensor 164 is comprised of a thermal resistor that sends an electrical current through the probe 160, wherein the probe 160 measures the voltage across the resistor and calculates said measurement into a temperature. In a further embodiment, the sensor 164 is comprised of a resistance temperature detector made from platinum, nickel, copper, etc. However, in any embodiment, the sensor 164 may be any type of temperature sensor or structure known in the art that can provide the internal temperature of food 10 in real time.

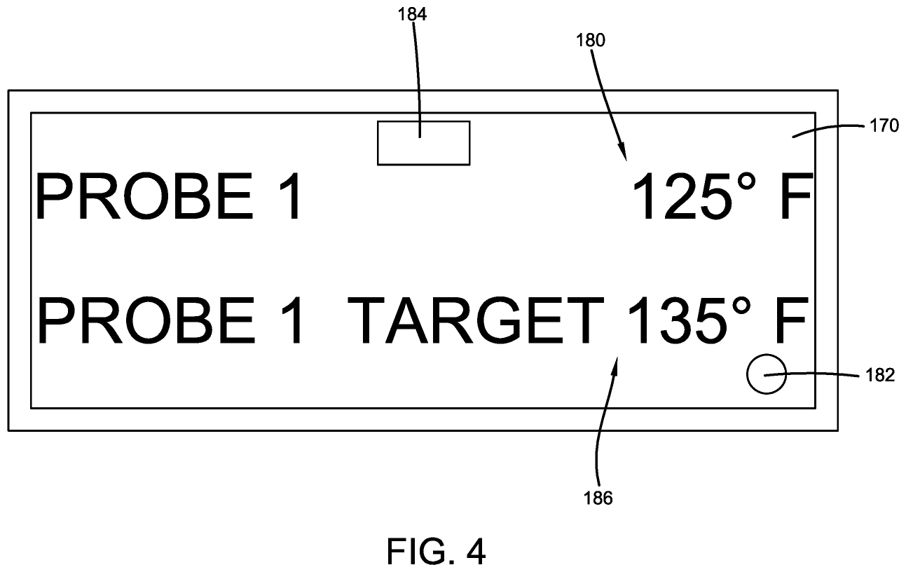

The temperature reading 180 from the sensor 164 of the probe 160 is communicated to at least one display 170 of the oven 110, as seen in FIG. 4. Said display 170 is preferably a separate display from any existing type of oven 110 display known in the art. However, in one embodiment the display 170 may be integrated into an existing oven 110 display known in the art.

The display 170 shows the user the real time, internal temperature of the food 10 being cooked within the oven 110 via the probe 160. In one embodiment, the display 180 is comprised of a temperature select button 182 which allows a user to select the desired temperature 186 for the food. Once said desired temperature 186 is recorded by the probe 160, the display 170 may produce an audible sound or alarm via at least one speaker 184. In this manner, a user need not continuously watch the display 170 until the food 10 reaches the desired temperature. It should be noted that the display 170 may show the real time temperature and/or the desired temperature 186 simultaneously or separately.

The temperature select button 182 may also allow a user to select pre-determined temperatures 186 to achieve various finishes of food 10. By way of example, the pre-determined temperatures 186 may be 125° F. (rare), 135° F. (medium rare), 145° F. (medium), 150° F. (medium-well), 160° F. (well-done) for beef. However, the pre-determined temperature may be based on the type of food/meat 10 being cooked.

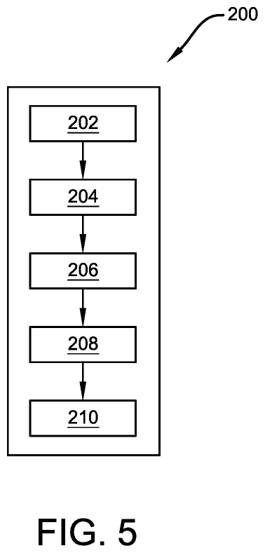

The present invention is also comprised of a first method of using 200 the device 100, as seen in FIG. 5. First, a device 100 is provided comprised of an oven 110 comprised of an interior space 120 with a female receptacle 130, a meat thermometer assembly 140 comprised of a plug 142 connected to a probe 160 with a sensor 164 via a connection wire 150, and a display 170 [Step 202]. Then, a piece of food 10, such as, but not limited to, a piece of meat, is placed into the interior space 120 for cooking [Step 204]. Then, the probe 160 is placed into the meat 10, such that the probe 160 can record the internal temperature of the meat [Step 206]. Then, the internal temperature of the meat 10 can be observed while cooking within the oven 110 until the internal temperature of the meat 10 has reached a desired internal temperature [Step 208]. Then, the meat 10 can be removed from the oven 110 once said desired internal temperature is reached [Step 210].

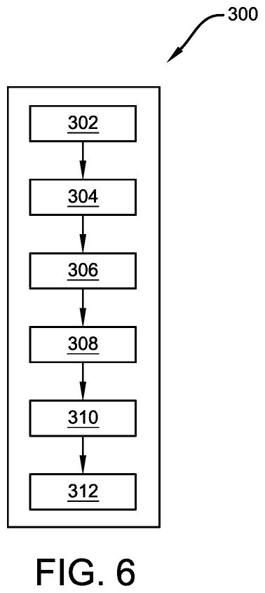

In addition, the present invention is also comprised of a second method of using 300 the device 100, as seen in FIG. 6. First, a device 100 is provided comprised of an oven 110 comprised of an interior space 120 with a female receptacle 130, a meat thermometer assembly 140 comprised of a plug 142 connected to a probe 160 with a sensor 164 via a connection wire 150, and a display 170 [Step 302]. Then, a piece of food 10, such as, but not limited to, a piece of meat, is placed into the interior space 120 for cooking [Step 304]. Then, the probe 160 is placed into the meat 10, such that the probe 160 can record the internal temperature of the meat [Step 306]. Next, a user can select a desired internal temperature of the meat 10 via a temperature select button 182 [Step 308]. Then, the internal temperature of the meat 10 can be observed while cooking within the oven 110 until the internal temperature of the meat 10 has reached a desired internal temperature at which time the device 100 produces a sound or alarm via a speaker 184 of the device 100 [Step 310]. Then, the meat 10 can be removed from the oven 110 once said desired internal temperature is reached [Step 312].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “oven device with internal meat thermometer device” and “device” are interchangeable and refer to the oven device with internal meat thermometer device 100 of the present invention.

Notwithstanding the foregoing, the oven device with internal meat thermometer device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the oven device with internal meat thermometer device 100 as shown in the FIGS. are for illustrative purposes only, and that many other sizes and shapes of the oven device with internal meat thermometer device 100 are well within the scope of the present disclosure. Although the dimensions of the oven device with internal meat thermometer device 100 are important design parameters for user convenience, the oven device with internal meat thermometer device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An oven device with internal meat thermometer device comprising:
an oven;
a display positioned on the oven; and
a probe comprised of a sensor, wherein the probe is in wired connection with the display.

2. The oven device with internal meat thermometer device of claim 1, wherein the sensor is comprised of a Type-K sensor.

3. The oven device with internal meat thermometer device of claim 2, wherein the Type-K sensor is comprised of a nickel and a chromium.

4. The oven device with internal meat thermometer device of claim 1, wherein a temperature detected by the sensor is shown on the display.

5. The oven device with internal meat thermometer device of claim 1, wherein the display shows a desired temperature.

6. An oven device with internal meat thermometer device comprising:
an oven;
a display positioned on the oven;
a speaker; and
a probe comprised of a sensor, wherein the probe is in wired connection with the display.

7. The oven device with internal meat thermometer device of claim 6, wherein the oven is comprised of an interior space.

8. The oven device with internal meat thermometer device of claim 6, wherein the probe is positioned in the interior space.

9. The oven device with internal meat thermometer device of claim 6, wherein the probe is comprised of a pointed tip.

10. The oven device with internal meat thermometer device of claim 6, wherein the sensor is comprised of a thermocouple sensor.

11. The oven device with internal meat thermometer device of claim 6, wherein the sensor is comprised of a thermal resistor.

12. The oven device with internal meat thermometer device of claim 6, wherein the probe produces a voltage.

13. The oven device with internal meat thermometer device of claim 6, wherein the sensor is comprised of s resistance temperature detector.

14. The oven device with internal meat thermometer device of claim 6, wherein a temperature detected by the probe is shown on the display.

15. The oven device with internal meat thermometer device of claim 6, wherein the display shows a desired temperature.

16. The oven device with internal meat thermometer device of claim 6, wherein the speaker produces a sound when a pre-selected temperature is reached.

17. The oven device with internal meat thermometer device of claim 16, wherein the pre-selected temperature is comprised of 125° F. (rare), 135° F. (medium rare), 145° F. (medium), 150° F. (medium-well), or 160° F. (well done).

18. The oven device with internal meat thermometer device of claim 16, wherein the pre-selected temperature is selected via a button the display.

19. A method of using an oven device with internal meat thermometer device, the method comprising the following steps:
providing an oven device with internal meat thermometer device comprised of an oven comprised of an interior space comprised of a meat thermometer assembly, and a display;
placing a piece of food into the interior space;
placing a probe of the meat thermometer assembly into the piece of food;
observing an internal temperature of the piece of food that is recorded by a sensor of the probe on the display; and
removing the piece of food from the oven once a desired internal temperature has been reached.

20. The method of claim 19, wherein the sensor is comprised of a temperature sensor.
